(19) United States
(12) Patent Application Publication
(10) Pub. No.: US 2018/0305512 A1
(43) Pub. Date: Oct. 25, 2018

(54) Styrenic Copolymers and Articles Therefrom

(71) Applicant: ExxonMobil Chemical Patents Inc., Baytown, TX (US)

(72) Inventors: Carlos R. Lopez-Barron, Houston, TX (US); Mosha H. Zhao, Houston, TX (US); Alan A. Galuska, Huffman, TX (US); Mark K. Davis, Humble, TX (US)

(21) Appl. No.: 15/946,526

(22) Filed: Apr. 5, 2018

Related U.S. Application Data
(60) Provisional application No. 62/489,516, filed on Apr. 25, 2017.

(51) Int. Cl. C08J 9/22; C08F 212/08; C08F 236/04

(52) U.S. Cl. CPC C08J 9/22; C08F 212/08; C08F 236/04; C08F 2500/17; C08F 2500/03; C08J 2205/06; C08J 2203/184; C08F 2500/01

(57) ABSTRACT

Strain-induced articles such as foamed, blow molded, or thermoformed articles comprising styrenic copolymers such as poly(vinylbiphenyl-co-styrene) having improved strain hardening and extensional viscosity for foaming and other applications, having a weight average molecular weight (Mw) of at least 100 kg/mole, comprising within the range from 5 to 80 wt % styrene derived units, and a process to form such styrenic copolymers, the process comprising combining styrene, a second aryl-containing monomer such as 4-vinylbiphenyl, and an initiator.

### CROSS REFERENCE TO RELATED APPLICATIONS

This application claims the benefit of priority from U.S. Provisional Application No. 62/489,516, filed Apr. 25, 2017, which is incorporated herein by reference.

### FIELD OF THE INVENTION

The present invention relates to styrenic copolymers having improved strain hardening and extensional viscosity for foaming applications, and in particular to poly(vinylbiphenyl-co-styrene) and methods of making such copolymers.

### BACKGROUND OF THE INVENTION

Polystyrene (“PS”) is useful in forming a wide range of articles due to its relative ease of processing as well as its good mechanical properties. However, the relatively low heat distortion temperature (“HDT”) of PS, which is about 100° C., impedes its use in application where the materials are exposed to high temperatures such as in foamed insulation and microwavable articles. Therefore, a facile way to improve the HDT of styrenic polymers is desirable.

Poly(4-vinylbiphenyl) (“PVBP”) has a HDT that is 55° C. higher than PS, but lacks the processability of PS. What is needed is a styrenic copolymer with improved processability but adequate HDT that would be useful in foamed, thermoformed, and/or blow molded applications.

Related publications include U.S. Pat. No. 2,471,785; U.S. Pat. No. 2,572,572; U.S. Pat. No. 5,082,358; and C. S. Marvel, R. E. Allen and C. G. Overberger in “The Preparation and Polymerization of Some Alkyl Styrenes,” in 68 J. AM. CHEM. SOC., 1088-1091 (1946).

### SUMMARY OF THE INVENTION

Disclosed is a process to form a strain-induced article such as a foamed, blow molded, or thermoformed article comprising (or consisting of, or consisting essentially of) at least one styrenic copolymer having a weight average molecular weight (“Mw”) of at least 100 kg/mole, the process comprising (or consisting of, or consisting essentially of) combining styrene with a second aryl-containing monomer using a free-radical initiator under conditions to effect copolymerization of the monomers, followed by inducing shear or extensional flow on the formed styrenic copolymer to form the strain-induced article.

Also disclosed are foamed, blow molded, or thermoformed articles comprising (or consisting of, or consisting essentially of) at least one styrenic copolymer having a weight average molecular weight (Mw) of at least 100 kg/mole, comprising (or consisting of, or consisting essentially of) within the range from 5 to 50, or 60, or 70, or 80 wt % styrene derived units, and within the range from 95 to 50, or 40, or 30, or 20 wt % of a second aryl-containing monomer derived units.

### BRIEF DESCRIPTION OF THE FIGURES

FIG. 1a are dynamic temperature ramps for poly(vinylbiphenyl-co-styrene) (“poly(VBP-co-S)”) copolymers and glass transition as a function of styrene content, where number in parenthesis is the weight percent of styrene-derived units in the polymer by weight of the polymer; FIG. 1b is a plot of the glass transition temperature (Tg) as a function of weight percent styrene in the poly(VBP-co-S), the Tg calculated by both DSC and G″.

FIG. 2 are complex viscosity traces as a function of frequency for poly(VBP-co-S) copolymers.

FIG. 3a, FIG. 3b, and FIG. 3c are transient extensional viscosity traces for poly(VBP-co-S) copolymers having 20, 40, and 80 wt % styrene derived units (respectively), and FIG. 3d of PS, each measured at 190° C.

FIG. 4a, FIG. 4b, and FIG. 4c are transient extensional viscosity traces for poly(VBP-co-S) copolymers having 20, 40, and 80 wt % styrene derived units (respectively), and FIG. 4d of PS, each measured at temperature equal to Tg+35° C.

### DETAILED DESCRIPTION

The inventors have found that copolymers of styrene with a second aryl-containing monomer such as 4-vinylbiphenyl, preferably random copolymers, have been found to result in amorphous polymers with HDT's intermediate between 100° C. and 150° C., with HDT being a function of the comonomer composition. Moreover, such copolymers have strong strain-hardening, at selected temperatures. Such copolymers would be useful in foamed articles, thermoformed articles, and blow molded articles.

Thus, in any embodiment is a process to form a strain-induced article comprising (or consisting of, or consisting essentially of) at least one styrenic copolymer having a Mw of at least 100 kg/mole, the process comprising (or consisting of, or consisting essentially of) combining styrene, a second aryl-containing monomer, and an initiator, followed by inducing shear on the formed styrenic copolymer to form the article. The styrenic copolymers may be of any form such as block copolymers, partial block copolymers (some block nature and some random nature), or random copolymers, but are most preferably random copolymers. There can be one type of styrenic copolymer, or a blend of two or more distinct styrenic copolymers present in the article.

Also, in any embodiment is a strain-induced article comprising (or consisting of, or consisting essentially of) at least one styrenic copolymer having a weight average molecular weight (Mw) of at least 100 kg/mole, comprising (or consisting of, or consisting essentially of) within the range from 5 to 50, or 60, or 70, or 80 wt % styrene derived units, and within the range from 95 to 50, or 40, or 30, or 20 wt % of a second aryl-containing monomer derived units.

By “strain-induced” what is meant is that an article is formed from a polymer such that the polymer experienced a pressure and/or other shear and/or extensional deformation that caused its layers and/or molecules to shift in relation to one another, examples of which include melt extrusion of a polymer and/or forming a foam of a polymer melt to form a film, sheet and/or article of a particular shape. Thus, for example, a foamed article formed from a polymer that has been foamed is a strain-induced article, as is a thermoformed article, blow molded article, or any other article that is formed from a polymer subjected to melt extrusion and/or some other force, such as, a melt passing against a metal surface and/or cavitated and/or blown by an external gas or internally generated gas. Strain-induced articles are thus distinguished in any embodiment from articles made by carrying out the polymerization to form the styrenic copolymer in a mold, or by impregnating the styrenic copolymer into a textile, or coating a surface with the liquid styrenic copolymer.

By “second aryl-containing monomer” what is meant is a polymerizable monomer other than styrene that comprises at least one aryl moiety, most preferably comprising at least one C5 to C8 aromatic ring, such as, for example, 4-vinylbiphenyl, 4-vinylcyclohexylstyrene, 4-methylstyrene, 3-cyclohexylstyrene, 4-cyclohexyl-ene-styrene, 4-vinylnaphthylene, and 4-vinyl-8-alkylnaphthylene, and substituted versions thereof, and partially hydrogenated versions thereof. In any embodiment, the second aryl-containing monomer is selected from 4-vinylbiphenyl, substituted versions thereof, and partially hydrogenated versions thereof.

By “partially hydrogenated” what is meant with respect to a second aryl-containing monomer or styrenic polymer is that some of the sites of unsaturation may be hydrogenated, but at least one aryl moiety remains. For example, a partially hydrogenated version of 4-vinylbiphenyl is 4-vinylcyclohexylstyrene. Thus, in any embodiment, the process herein further comprises hydrogenating the styrenic copolymer partially.

By “substituted” or “substituted versions thereof” what is meant is the named polymer and/or monomer having one or more hydrogen atoms substituted for another atom or moiety, such as a C1 to C6, or C10 alkyl, a C6 to C20 aryl, a C7 to C22 alkylaryl, a C7 to C22 arylalkyl, a C1 to C6 or C10 alkoxy, a hydroxyl group, carboxy group, an amine group, a mercaptan group, a sulfate group, a phosphate group, a halogen, and combinations thereof. Most preferably, the polymers and/or monomers are not substituted.

In any case, the process includes, or comprises, controlling the rheological properties of styrenic copolymer by varying the amount of styrene combined with respect to second aryl-containing monomer and initiator. For example, in any embodiment, the process comprises controlling the glass transition temperature (Tg) of the styrenic copolymer to within a range from 80, or 100° C. to 160, or 180, or 200° C. by varying the amount of styrene combined with respect to second aryl-containing monomer and initiator. Also, in any embodiment, increasing the amount of styrene decreases the Tg of the styrenic copolymer.

In any embodiment, the styrenic copolymers herein are formed by free radical polymerization. “Free radical polymerization” is a method of polymerization by which a polymer forms by the successive addition of free radical building blocks. Free radicals can be formed via a number of different mechanisms usually involving separate initiator molecules. Following its generation, the initiating free radical adds (non-radical) monomer units, thereby growing the polymer chain. Such polymerization is ideally a living polymerization.

There are several ways in which the inventive polymerizations can be initiated, including thermal decomposition, photolysis, redox reactions, ionizing radiation, electrochemical, plasma, sonication, and/or the use of chemical initiators such as azo-compounds, diazo-compounds, peroxides, and persulfates. A combination of one or more of these methods may be used. The use of chemical initiators is preferred, and azo- and diazo-compounds are particularly preferred and include compounds of the general structure R—N═N—R and/or R—C≡N, wherein each “R” radical can be the same or different; most preferably, at least one “R” group of the azo-compounds includes at least one group. Examples of suitable initiators include air (oxygen), n-hydroxyphthalimide, t-butylperoxide, cumene hydroperoxide, azobisisobutyronitrile, and 1,1′-azobis(cyclohexanecarbonitrile).

Various reaction conditions effect copolymerization of monomers once contacted with one another. In any embodiment, the level of such initiator (e.g., free-radical initiator) in the reaction with the monomer is within a range from 0.0001 or 0.001 to 0.005 or 0.01 weight initiator/weight monomer ratio. Also, in any embodiment, the monomers and initiator are combined at a temperature within the range from 70 or 80° C. to 120, or 140, or 180, or 200° C., meaning that the medium (e.g., solvent and/or monomers) and/or vessel in which the combination takes place is kept at such an average temperature. There are several methods to carry out the copolymerization process—the process of combining styrene, a second aryl-containing monomer, and an initiator—as disclosed herein, including:
Bulk polymerization: the reaction mixture contains only one or more initiators and monomer(s), no, or only a minor amount, of solvent (less than 5, or 4, or 1 wt %) is present.
Solution polymerization: the reaction mixture contains solvent, at least one initiator, and monomer(s).
Suspension polymerization: the reaction mixture contains an aqueous phase, water-insoluble monomer(s), and initiator soluble in the monomer droplets (both the monomer(s) and at least one initiator are typically hydrophobic).
Emulsion polymerization: similar to suspension polymerization except that the initiator(s) is soluble in the aqueous phase rather than in the monomer(s) droplets (the monomer(s) is typically hydrophobic, and at least one initiator is typically hydrophilic). An emulsifying agent may also be needed.

The second aryl-containing monomer and styrene may also be polymerized in the presence other vinyl monomers (including, but not limited to, ethylene and other C3 to C12 α-olefins, methyl styrene, acrylate esters, or methacrylate esters) and/or diene-containing monomers including, but not limited to, butadiene, isoprene, dicyclopentadiene, divinyl benzene, ethylidenenorbornene, and vinyl norbornene, such incorporation performed in order to improve the balance of properties. In any embodiment, the styrenic copolymers, or the articles made therefrom, consist of (or consist essentially of) polymers made from 4-vinylbiphenyl and styrene.

In any embodiment, the styrenic copolymer has a molecular weight distribution (weight average molecular weight/number average molecular weight, or “Mw/Mn”) of less than 4, or 3, or 2.5, or 2.2, or 2, or within a range from 4, or 3, or 2.5, or 2.2, or 2 to 1.5, or 1.2, or 1. Also, in any embodiment, the styrenic copolymer has Mw within a range from 100, or 120, or 140, or 160 kg/mole to 300, or 350, or 400 kg/mole. Also, in any embodiment, at a temperature (T) of Tg+35° C., or at 190° C., the styrenic copolymer exhibits strain hardening, which is an increase in the copolymer's viscosity as a function of time relative to the LVE in a strain-controlled rheometer at a strain rate of 0.01, or 0.1, or 1, or 10 s⁻¹. Most preferably, the styrenic copolymer exhibits a strain hardening of at least 100, or 200, or 300, or 400, or 500 kPa·s over the LVE at 190° C. or Tg+35° C., or within a range from 100, or 200, or 300, or 400, or 500 kPa·s to 800, or 1000, or 1200 kPa·s.

A particularly preferred styrenic copolymer is poly(vinylbiphenyl-co-styrene), which may be substituted and/or partially hydrogenated. In any embodiment, the poly(vinylbiphenyl-co-styrene) has Mw of at least 100, or 120, or 140, or 160 kg/mole, and comprises (or consisting of, or consisting essentially of) within the range from 5 to 50, or 60, or 70, or 80 wt % styrene derived units, the remainder being 4-vinylbiphenyl derived units. In any embodiment, the poly(vinylbiphenyl-co-styrene) has an Mw/Mn of less than 4, or 3, or 2.5, or 2.2, or 2, or within a range from 4, or 3, or 2.5, or 2.2, or 2 to 1.5, or 1.2, or 1. Also in any embodiment, the poly(vinylbiphenyl-co-styrene) has an Mw within a range from 100, or 120, or 140, or 160 kg/mole to 300, or 350, or 400 kg/mole. Also, in any embodiment, at a temperature (T) of Tg+35° C., or simply at 190° C., the poly(vinylbiphenyl-co-styrene) exhibits strain hardening, which is an increase in the copolymer's viscosity as a function of time relative to the LVE in a strain-controlled rheometer at a strain rate of 0.01, or 0.1, or 1, or 10 s⁻¹. Most preferably, the poly(vinylbiphenyl-co-styrene) exhibits a strain hardening of at least 100, or 200, or 300, or 400, or 500 kPa·s over the LVE at 190° C. or at Tg+35° C., or a strain hardening within a range from 100, or 200, or 300, or 400, or 500 kPa·s to 800, or 1000, or 1200 kPa·s.

The styrenic copolymer can be formed into useful strain-induced articles. For instance, in any embodiment, a foamed article can be formed from the styrenic copolymer or styrenic copolymer in a blend with another polymer and/or additive (e.g., filler, anti-oxidant, etc.). Foaming agents useful in forming foamed articles described herein may be normally gaseous, liquid, or solid compounds or elements, or mixtures thereof. These foaming agents may be characterized as either physically-expanding or chemically decomposing. Of the physically expanding foaming agents, the term “normally gaseous” is intended to mean that the expanding medium employed is a gas at the temperatures and pressures encountered during the preparation of the foamable compound, and that this medium may be introduced either in the gaseous or liquid state as convenience would dictate. Such agents can be added to the styrenic copolymers by blending the dry polymer with the foaming agent followed by melt extrusion, or by blending the agents in the polymer melt during extrusion. The foaming agent, especially gaseous agent, may be blended with the polymer melt as it exits the melt extruder or mold that is used for forming the foamed articles.

Included among exemplary, normally gaseous and liquid foaming agents are the halogen derivatives of methane and ethane, such as methyl fluoride, methyl chloride, difluoromethane, methylene chloride, perfluoromethane, trichloromethane, difluoro-chloromethane, dichlorofluoromethane, dichlorodifluoromethane, trifluorochloromethane, trichloromonofluoromethane, ethyl fluoride, ethyl chloride, 2,2,2-trifluoro-1,1-dichloroethane, 1,1,1-trichloroethane, difluoro-tetrachloroethane, 1,1-dichloro-1-fluoroethane, 1,1-difluoro-1-chloroethane, dichloro-tetrafluoroethane, chlorotrifluoroethane, trichlorotrifluoroethane, 1-chloro-1,2,2,2-tetrafluoroethane, 1,1-difluoroethane, 1,1,1-trifluoroethane, 1,1,1,2-tetrafluoroethane, perfluoroethane, pentafluoroethane, 2,2-difluoropropane, 1,1,1-trifluoropropane, perfluoropropane, dichloropropane, difluoropropane, chloroheptafluoropropane, dichlorohexafluoropropane, perfluorobutane, perfluorocyclobutane, sulfur-hexafluoride, and mixtures thereof. Other normally gaseous and liquid foaming agents that may be employed are hydrocarbons and other organic compounds, such as acetylene, ammonia, butadiene, butane, butene, isobutane, isobutylene, dimethylamine, propane, dimethylpropane, ethane, ethylamine, methane, monomethylamine, trimethylamine, pentane, cyclopentane, hexane, propane, propylene, alcohols, ethers, ketones, and the like. Inert gases and compounds, such as nitrogen, argon, neon or helium, can also be used as foaming agents with satisfactory results.

Solid, chemically decomposable foaming agents, which decompose at elevated temperatures to form gasses, can be used to expand the styrenic copolymers. In general, the decomposable foaming agent will have a decomposition temperature (with the resulting liberation of gaseous material) from 130° C. to 200, or 250, or 300, or 350° C. Exemplary chemical foaming agents include azodicarbonamide, p,p′-oxybis(benzene) sulfonyl hydrazide, p-toluene sulfonyl hydrazide, p-toluene sulfonyl semicarbazide, 5-phenyltetrazole, ethyl-5-phenyltetrazole, dinitroso pentamethylenetetramine, and other azo, N-nitroso, carbonate, and sulfonyl hydrazide compounds, as well as, various acid/bicarbonate compounds which decompose when heated. Representative volatile liquid foaming agents include isobutane, difluoroethane, or blends of the two. For decomposable solid foaming agents, azodicarbonamide is preferred, while for inert gasses, carbon dioxide is preferred.

The art of producing foam structures is known, especially for styrenic compositions. The foamed articles of the present invention may take any physical configuration known in the art, such as sheet, plank, other regular or irregular extruded profile, and regular or irregular molded bun stock. Exemplary of other useful forms of foamed or foamable objects known in the art include expandable or foamable particles, moldable foam particles, or beads, and articles formed by expansion and/or consolidation and fusing of such particles. In any embodiment, the foamable article or styrenic copolymers may be cross-linked prior to expansion, such as for the process of free-radical initiated chemical cross-linking or ionizing radiation, or subsequent to expansion. Cross-linking subsequent to expansion may be effected by exposure to chemical cross-linking agents or radiation or, when silane-grafted polymers are used, exposure to moisture optionally with a suitable silanolysis catalyst.

Illustrative, but non-limiting, of methods of combining the various ingredients of the foamable styrenic copolymers include melt-blending, diffusion-limited imbibition, liquid-mixing, and the like, optionally with prior pulverization or other particle-size reduction of any or all ingredients. Melt-blending may be accomplished in a batchwise or continuous process, and is preferably carried out with temperature control. Furthermore, many suitable devices for melt-blending are known to the art, including those with single and multiple Archimedean-screw conveying barrels, high-shear “Banbury” type mixers, and other internal mixers. The object of such blending or mixing, by means and conditions which are appropriate to the physical processing characteristics of the components, is to provide therein a uniform mixture. One or more components may be introduced in a step-wise fashion, either later during an existing mixing operation, during a subsequent mixing operation, or, as would be the case with an extruder, at one or more downstream locations into the barrel.

Expandable or foamable styrenic copolymers will have a foaming agent incorporated therein, such as a decomposable or physically expandable chemical blowing agent, so as to effect the expansion in a mold upon exposure of the composition to the appropriate conditions of heat and, optionally, the sudden release of pressure. The styrenic copolymers find many uses as foamed articles including automotive components, insulation and other construction components, food containers, sports equipment, and other domestic and commercial uses.

The styrenic copolymers can also be thermoformed to make useful strain-induced articles. Thermoforming is a manufacturing process where the styrenic copolymer sheet is heated to a pliable forming temperature, formed to a specific shape in a mold, and trimmed to create a usable product. The sheet, or “film” when referring to thinner gauges and certain material types, is heated in an oven to a high-enough temperature that permits it to be stretched into or onto a mold and cooled to a finished shape. Its simplified version is vacuum forming. The styrenic copolymers described herein can desirably be formed into films or sheets suitable for thermoforming processes.

In any embodiment, a small tabletop or lab size machine can be used to heat small cut sections of styrenic copolymer sheet and stretch it over a mold using vacuum. This method is often used for sample and prototype parts. In complex and high-volume applications, very large production machines can be utilized to heat and form the styrenic copolymer sheet and trim the formed parts from the sheet in a continuous high-speed process, and can produce many thousands of finished parts per hour depending on the machine and mold size and the size of the parts being formed. The styrenic copolymers described herein are suitable for both types of thermoforming.

One desirable type of thermoforming is thin-gauge thermoforming. Thin-gauge thermoforming is primarily the manufacture of disposable cups, containers, lids, trays, blisters, clamshells, and other products for the food, medical, and general retail industries. Thick-gauge thermoforming includes parts as diverse as vehicle door and dash panels, refrigerator liners, utility vehicle beds, and plastic pallets. Heavy-gauge forming utilizes the same basic process as continuous thin-gauge sheet forming, typically draping the heated plastic sheet over a mold. Many heavy-gauge forming applications use vacuum only in the form process, although some use two halves of mating form tooling and include air pressure to help form.

In any embodiment, a sheet comprising (or consisting essentially of) the styrenic copolymer is fed from a roll or from an extruder into a set of indexing chains that incorporate pins, or spikes, that pierce the sheet and transport it through an oven for heating to forming temperature. The heated sheet then indexes into a form station where a mating mold and pressure-box close on the sheet, with vacuum then applied to remove trapped air and to pull the material into or onto the mold along with pressurized air to form the plastic to the detailed shape of the mold. Plug-assists are typically used in addition to vacuum in the case of taller, deeper-draw formed parts in order to provide the needed material distribution and thicknesses in the finished parts. In any case, after a short form cycle, a burst of reverse air pressure is actuated from the vacuum side of the mold as the form tooling opens, commonly referred to as air-eject, to break the vacuum and assist the formed parts off of, or out of, the mold. A stripper plate may also be utilized on the mold as it opens for ejection of more detailed parts or those with negative-draft, undercut areas. The styrenic copolymer sheet containing the formed parts then indexes into a trim station on the same machine, where a die cuts the parts from the remaining sheet web, or indexes into a separate trim press where the formed parts are trimmed. The sheet web remaining after the formed parts are trimmed is typically wound onto a take-up reel or fed into an inline granulator for recycling.

Generally, styrenic copolymers find use in making many thermoformed articles, such as automotive components, construction components, electronic devices, medical equipment, windshields for automobiles and aircraft, sports equipment, food containers, appliances, and other domestic and commercial uses. Similarly, the styrenic copolymers can find use strain-induced articles made from injection molding, blow molding, and rotational molding processes.

In a particularly preferred embodiment is a foamed, blow molded, or thermoformed article comprising (or consisting of, consisting essentially of) poly(vinylbiphenyl-co-styrene) having a Mw of at least 100 kg/mole, comprising (or consisting of, or consisting essentially of) within the range from 5 to 50, or 60, or 70, or 80 wt % styrene derived units, the poly(vinylbiphenyl-co-styrene) having a Mw/Mn of less than 3, or 2.5, or 2.2, or 2, and wherein at a temperature of 190° C. the poly(vinylbiphenyl-co-styrene) exhibits strain hardening.

In any embodiment, the articles formed from the styrenic copolymers, or blends thereof, may be cross-linked to enhance performance (such as thermal stability and durability). In any embodiment, any of these articles may be cross-linked, which can be effected by any means, including, but not limited to, chemical cross-linking (using cross-linking agents containing sulfur, peroxide, amine, halide, etc.) and radiation induced cross-linking (using radiation types such as electrons, x-rays, ions, neutrons, gamma-radiation, and ultraviolet).

In any embodiment, blends of styrenic copolymers described herein, cross-linked or not, can comprise any combination of second polymer(s) such as polyethylene, polypropylene, ethylene-propylene copolymers, butyl rubber, polyisoprene, polybutadiene, polystyrene, styrene butadiene, polyamides, polyesters, polyurethanes, polyacrylates, and combinations thereof. In any embodiment, the styrenic copolymer comprises within a range from 5, or 10 wt % to 20, or 30, or 40, or 50 wt % of the second polymer as a blend. The styrenic copolymer may also be associated with one or more of the second polymers in an article as co-components of the article, such as layers or parts of the article.

### EXAMPLES

Test methods and experimental procedures are described here. The various descriptive elements and numerical ranges disclosed herein for the inventive styrenic copolymers, and in particular, poly(VBP-co-S) copolymers, and processes for making them can be combined with other descriptive elements and numerical ranges to describe the invention(s); further, for a given element, any upper numerical limit can be combined with any lower numerical limit described herein, including the examples in jurisdictions that allow such combinations. The features of the inventions are demonstrated in the following non-limiting examples.

Molecular Weight Characteristics.

The Mw, Mn and Mw/Mn were determined by using a High Temperature Gel Permeation Chromatography (“GPC”) (Agilent PL-220), equipped with three in-line detectors, a differential refractive index detector (“DRI”), a light scattering (“LS”) detector, and a viscometer. Detector calibration is described in a paper by T. Sun, P. Brant, R. R. Chance, and W. W. Graessley, in 34(19) MACROMOLECULES, 6812-6820 (2001). Three Agilent PLgel 10 μm Mixed-B LS columns were used for the GPC tests herein. The nominal flow rate was 0.5 mL/min, and the nominal injection volume was 300 μL. The various transfer lines, columns, viscometer and differential refractometer (the DRI detector) were contained in an oven maintained at 145° C. Solvent for the experiment was prepared by dissolving 6 grams of butylated hydroxytoluene as an antioxidant in 4 liters of Aldrich reagent grade 1,2,4-trichlorobenzene (“TCB”). The TCB mixture was then filtered through a 0.1 μm polytetrafluoroethylene filter. The TCB was then degassed with an online degasser before entering the GPC. Polymer solutions were prepared by placing dry polymer in a glass container, adding the desired amount of TCB, then heating the mixture at 160 C with continuous shaking for about 2 hours. All quantities were measured gravimetrically. The TCB densities used to express the polymer concentration in mass/volume units were 1.463 g/ml at 23° C. and 1.284 g/ml at 145° C. The injection concentration was from 0.5 to 2.0 mg/ml, with lower concentrations being used for higher molecular weight samples. Prior to running each sample the DRI detector and the viscometer were purged. The flow rate in the columns was then increased to 0.5 ml/minute, and the DRI was allowed to stabilize for 8 hours before injecting the first sample. The LS laser was turned on at least 1 to 1.5 hours before running the samples at an equilibrated temperature of 145° C. The concentration, c, at each point in the chromatogram was calculated from the baseline-subtracted DRI signal, I_{DRI}, using the following equation:

c=K_{DRI}I_{DRI}/(dn/dc),

where K_{DRI} is a constant determined by calibrating the DRI, and (dn/dc) is the incremental refractive index for the system. The refractive index, n, was 1.500 for TCB at 145° C. and λ was 690 nm. Units of molecular weight are expressed in kg/mole or g/mole, and intrinsic viscosity is expressed in dL/g.

The LS detector was a Wyatt Technology High Temperature Dawn Heleos. The molecular weight, M, at each point in the chromatogram was determined by analyzing the LS output using the Zimm model for static light scattering (W. Burchard & W. Ritchering, “Dynamic Light Scattering from Polymer Solutions,” in 80 PROGRESS IN COLLOID & POLYMER SCIENCE, 151-163 (Steinkopff, 1989)) and determined using the following equation:

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, “c” is the polymer concentration determined from the DRI analysis, A₂ is the second virial coefficient, P(θ) is the form factor for a mono-disperse random coil, and Kₒ is the optical constant for the system, as set forth in the following equation:

$${K}_{o} = \frac{4 {π}^{2} {{n}^{2} ( dn / dc )}^{2}}{{λ}^{4} {N}_{A}} ,$$

where N_{A} is Avogadro's number, and (dn/dc) is the incremental refractive index for the system, which takes the same value as the one obtained from DRI method, and the value of “n” is as above.

A high temperature Viscotek Corporation viscometer, which has four capillaries arranged in a Wheatstone bridge configuration with two pressure transducers, was used to determine specific viscosity. One transducer measures the total pressure drop across the detector, and the other, positioned between the two sides of the bridge, measures a differential pressure. The specific viscosity (ηₛ) for the solution flowing through the viscometer was calculated from their outputs. The intrinsic viscosity, at each point in the chromatogram was calculated from the following equation:

ηₛ=c[η]+0.3(c[η])²,

where “c” is concentration and was determined from the DRI output. The average intrinsic viscosity, [η]_{avg}, of the sample was calculated using the following equation:

$${[ η ]}_{avg} = \frac{\sum {{c}_{i} [ η ]}_{i}}{\sum {c}_{i}} ,$$

where the summations are over the chromatographic slices, i, between the integration limits. For data processing, the Mark-Houwink constants used were K=0.000579 and a=0.695. Values for Mn are ±50 g/mole, and for Mw are ±100 g/mole.

Differential Scanning Calorimetry.

Glass transition temperatures (Tg) were measured by Differential Scanning calorimetry (“DSC”) carried out on the styrenic copolymers using a TA Instruments Model Q-200 differential scanning calorimeter. DSC measures the amount of energy absorbed or released by a sample when it is heated or cooled, providing quantitative and qualitative data on endothermic (heat absorption) and exothermic (heat evolution) processes. To perform the study, a sample was placed in a T-Zero Pan and encapsulated with a lid using a pan press. The sample pan was placed upon a disc on a platform in the DSC cell. An empty reference pan sits on a symmetric platform in the DSC cell. Heat flow was measured by comparing the difference in temperature across the sample and the reference. Sample sizes are from 3.5 mg to 7.5 mg. The samples were first cooled from 20 to −100° C. at a rate of 10° C./minute. The samples were then heated from −100° C. to 280° C. at a rate of 10° C./min. During both cooling and heating a nitrogen gas purge flow at a rate of 50 ml/min was maintained. Note that a single heating cycle was used to minimize potential polymer degradation since the polymers did not contain any heat stabilizing additives. All the DSC plots on cooling and heating were recorded. The glass transition temperature (Tg) was determined from the heating thermogram as described in ASTM E1356.

Dynamic Mechanical Thermal Analysis.

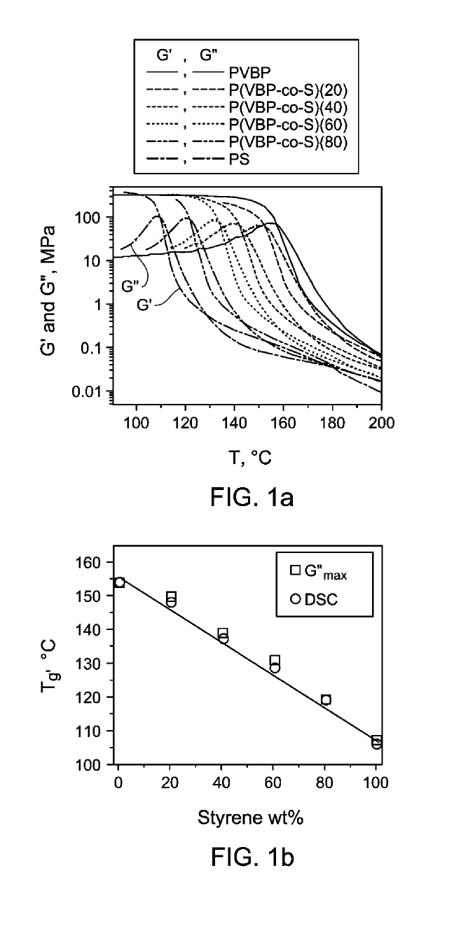

Glass transition temperatures (Tg) were also measured by dynamic mechanical thermal analysis (“DMTA”). A strain-controlled rheometer ARES-G2 (TA Instruments) was used for dynamic temperature ramp measurements using 8 mm serrated parallel plate geometry. The specimens consist on 8 mm discs of the sample that are sandwiched between the plates and subjected to small-amplitude oscillatory shear flow with frequency of 1 Hz and strain amplitudes of 0.1% while the temperature is ramped down from 220 to 100° C. The rheometer software (TRIOS) calculates the dynamic elastic and viscous moduli (G′ and G″, respectively). The Tg value is determined as the temperature at which a maximum in the G″ values is observed during the temperature ramp, as shown in FIG. 1a.

Shear Thinning.

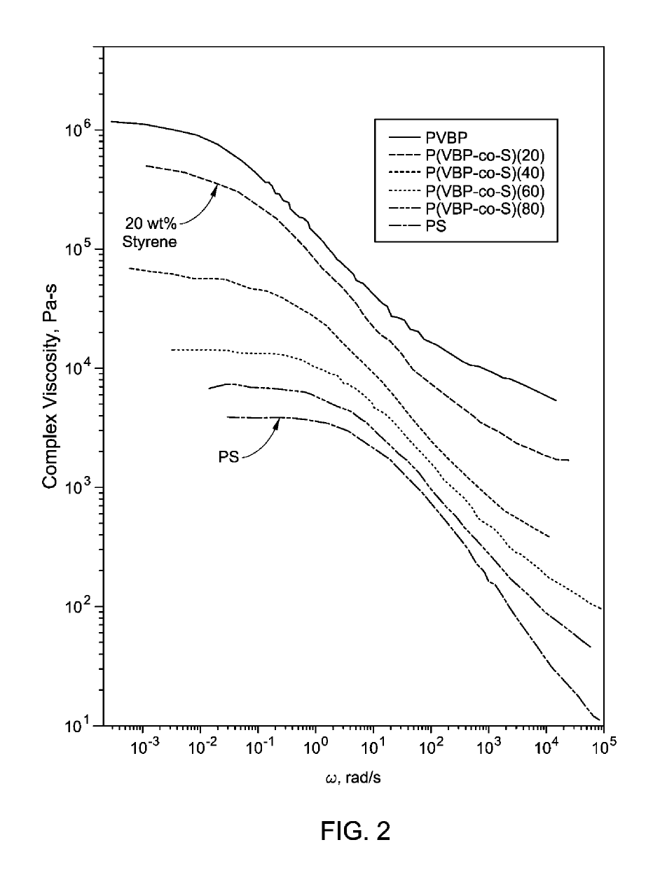

Small Angle Oscillatory Spectroscopy (“SAOS”) was performed on the inventive samples polystyrene, traces for which are shown in FIG. 2. Prepared using hot press (either a Carver Press or Wabash Press) polymer samples were disks of 25 mm in diameter and 2.5 mm in thickness. In order to characterize the shear thinning behavior the rheometer ARES-G2 (TA Instruments) was used to conduct small angle oscillatory shear measurements at angular frequency ranging from 0.01 to 500 rad/s at temperatures ranging from 160° C. to 250° C. and at a fixed strain of 10%. The dynamic moduli data measured at different temperature are shifted horizontally to construct a dynamic master curves using the time-temperature superposition principle, with a reference temperature T₀=190° C. The dynamic moduli data was then converted into viscosity as function of frequency. To ensure that selected strain provides measurements within linear deformation range the strain sweep measurements have been conducted (at angular frequency of 100 Hz). Data was processed using Trios software.

Extensional Strain Hardening.

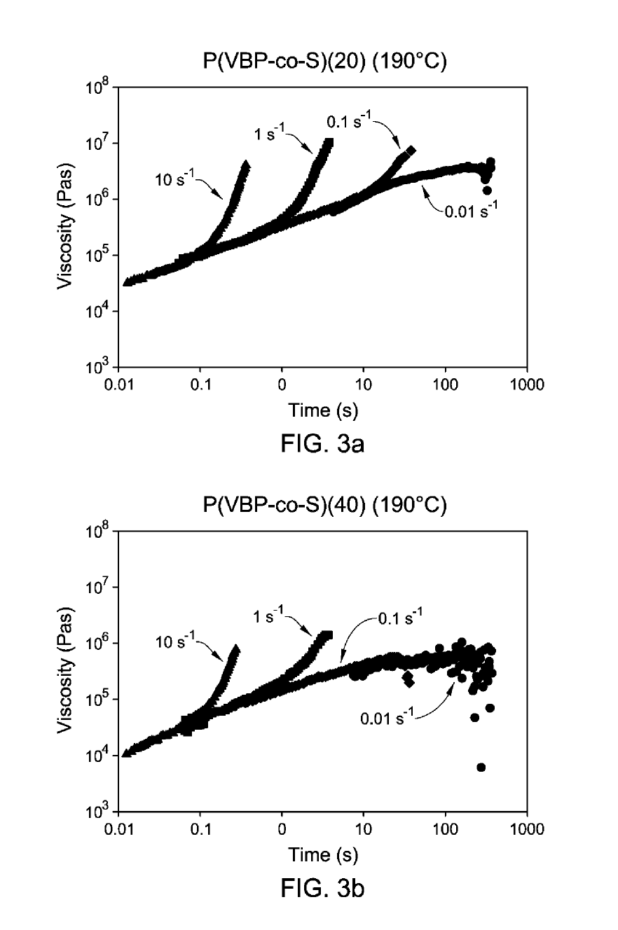

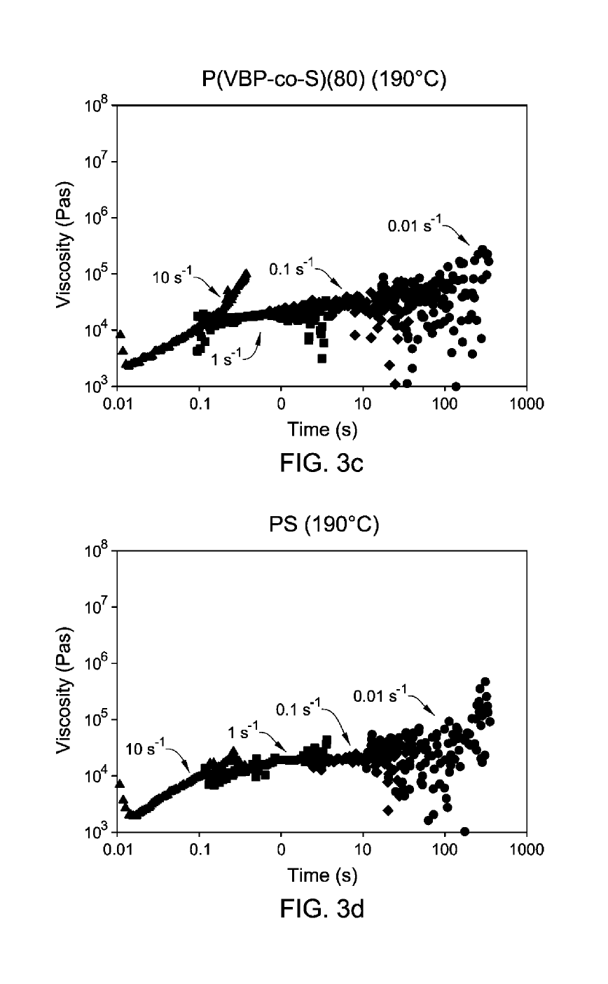

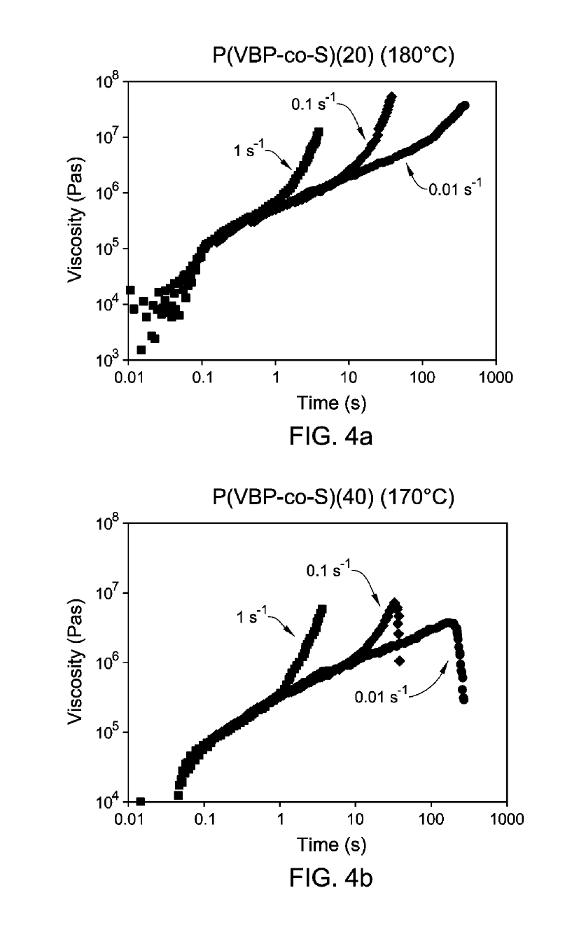

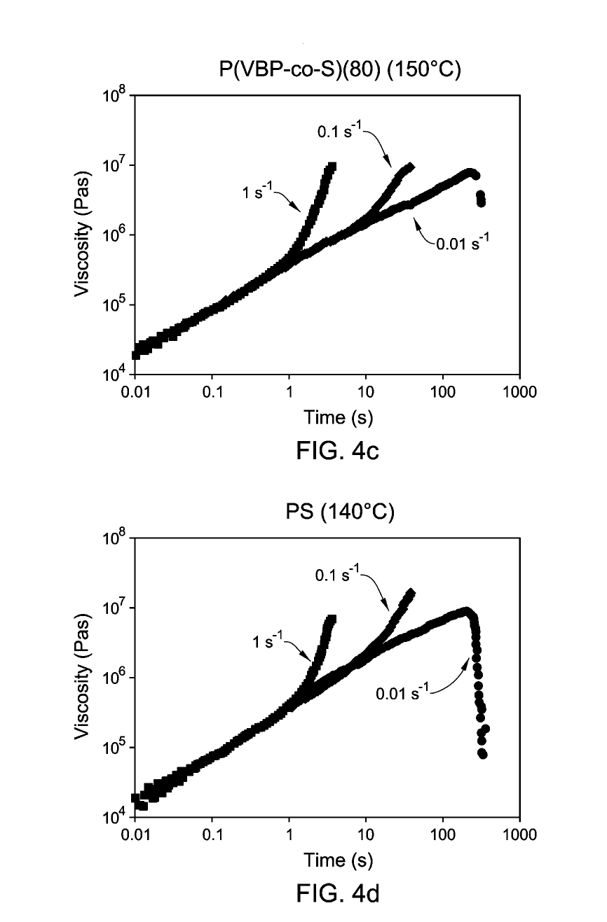

The extensional strain hardening shown in traces in FIG. 3 and FIG. 4 were obtained using a Sentmanat Extensional Rheometer (“SER”), mounted on a strain-controlled rheometer (ARES-G2, TA Instruments). All the measurements in the FIG. 3 series were performed at 190° C., under nitrogen atmosphere. All the measurements in the FIG. 4 series were performed at a temperature Tg+35° C.

Synthesis of poly(PVB-co-S).

Poly(4-vinylbiphenyl-co-styrene) random copolymers, poly(VBP-co-S) or “p(VPB-co-S)”, were prepared by free radical polymerization using azobisisobutyronitrile as the initiator. Polystyrene and polyvinylbiphenyl (“PVBP”) were also made, and their properties measured for comparison. In a rounded bottom flask, 4-vinylbiphenyl (“4-VBP”) and styrene (“S”) monomer were contacted and mixed with the weight percent (“wt %”) of styrene indicated in Table 1 (by weight of all monomers). Toluene was added to the mixture to make solutions with 30 wt % of monomers. The solutions were heated to 100° C. and stirred for 12 hours. The formed polymer was precipitated in cold methanol. The precipitate subsequently dried at 23° C. for 24 hours followed by 12 hours at 90° C. under vacuum. The molecular weight of the products was measured by GPC using a light scattering detector. The composition and molecular characteristics of these polymers are given in Table 1, where the parenthetical number is the weight percent of styrene-derived units in the polymer by weight of the copolymer.

TABLE 1
Copolymer composition and MW and properties

| | | | | | Tg | Tg |
|---|---|---|---|---|---|---|
| Polymer | wt % | Mw | | Viscosity | G″ | DSC |
| ID | Styrene | (kg/mol) | Mw/Mn | (Pa-s) | (° C.) | (° C.) |
| PVBP | 0 | 250 | 2.1 | 1.12 × 10⁶ | 154 | 154 |
| p(VBP-co-S) | 20 | 187 | 3.7 | 4.92 × 10⁵ | 150 | 148 |
| (20) | | | | | | |
| p(VBP-co-S) | 40 | 199 | 2.1 | 6.00 × 10⁴ | 139 | 138 |
| (40) | | | | | | |
| p(VBP-co-S) | 60 | 130 | 2.9 | 1.43 × 10⁴ | 131 | 129 |
| (60) | | | | | | |
| p(VBP-co-S) | 80 | 150 | 2.2 | 7.16 × 10³ | 120 | 120 |
| (80) | | | | | | |
| Polystyrene | 100 | 159 | 2.3 | 3.97 × 10³ | 108 | 106 |
| (PS) | | | | | | |

All the poly(VBP-co-S) copolymers were highly transparent and completely amorphous. Their glass transition temperatures (Tg) (measured by DMTA and DSC) are given in Table 1 and shown in FIG. 1b. The single glass transition and the nearly linear dependence of Tg with styrene-derived comonomer content indicates that the copolymers are random. The Tg and HDT are tightly correlated for amorphous polymers, such as the poly(VBP-co-S). Hence, the data shown in FIG. 1a and FIG. 1b demonstrate that HDT is easily tuned by varying the composition in the copolymer.

Small-amplitude oscillatory rheometry was performed at 190° C. on all the poly(VBP-co-S) copolymers, including the neat polyvinylbiphenyl (“PVBP”) and polystyrene (“PS”) samples. The complex viscosity as a function of frequency is shown in FIG. 2. Strong shear thinning was observed in all the copolymers, which indicates good processability for shear operations (such as extrusion or injection molding). The zero-shear viscosity (shown in Table 1) increases 3 orders of magnitude from neat PS to neat PVBP. This increase doesn't account for the increase due to molecular weight, which for polydisperse linear polymers typically follows the power law: the viscosity at about a weight average molecular weight Mw^{3.4}. This implies that the melt strength can be tuned by adjusting the comonomer composition in the copolymers.

The melt response to elongational flow of the poly(VBP-co-S) copolymers was measured. The data in the series of FIG. 3 shows extensional viscosity data for the poly(VBP-co-S) copolymers at 20 wt % and 40 wt % styrene derived units, and polystyrene, during start-up experiments performed at 190° C. and the indicated Hencky strain rates. The deviations from the linear viscoelastic envelop (“LYE” in these figures is an extrapolation of the baseline of the curves) is a measure of strain-hardening, where a larger deviation from linearity indicates more strain hardening. A strong strain-hardening was observed for the copolymer with 20 wt % styrene content (poly(VBP-co-S) (20)), and the strain-hardening strength decreases as the styrene content was increased in the copolymer. To counteract this weakening in extensional strain-hardening, the temperature can be reduced, as shown in the series of data in FIG. 4, which shows extensional viscosity data measured at different temperatures corresponding to a constant temperature difference (35° C.) from the Tg of the copolymers, or Tg+35° C. Measurements are shown for styrenic copolymers having 20 and 80 wt % styrene derived units and polystyrene. At those temperatures, all the copolymers show good strain hardening. The stain hardening response implies good processability in operations involving extensional flow (e.g., thermoforming, foaming, and blow molding). One potential application for these materials is in expanded polymers formed by commercial foaming processes for insulation to replace expanded polystyrene. The good processability combined with the high Tg of these polymers provide advantages over polystyrene foams.

As used herein, “consisting essentially of” means that the claimed article or polymer or polymer blend includes only the named components and no additional components that will alter its measured properties by any more than 20, or 15, or 10%, and most preferably means that additional components are present to a level of less than 5, or 4, or 3, or 2 wt % by weight of the composition. Such additional components can include, for example, fillers, colorants, antioxidants, alkyl-radical scavengers, anti-UV agents, acid scavengers, curatives and cross-linking agents, aliphatic and/or cyclic containing oligomers or polymers, often referred to as hydrocarbon resins, and other additives well known in the art. As it relates to a process, the phrase “consisting essentially of” means that there are no other process features that will alter the claimed properties of the polymer, polymer blend or article produced therefrom by any more than 10, 15 or 20%.

For all jurisdictions in which the doctrine of “incorporation by reference” applies, all of the test methods, patent publications, patents and reference articles are hereby incorporated by reference either in their entirety or for the relevant portion for which they are referenced.

1. A strain-induced article comprising at least one styrenic copolymer having a weight average molecular weight (Mw) of at least 100 kg/mole, comprising within the range from 5 to 80 wt % styrene derived units, and within the range from 95 to 20 wt % of a second aryl-containing monomer derived units, wherein the second aryl-containing monomer is selected from 4-vinylbiphenyl, substituted versions thereof, and partially hydrogenated versions thereof.

2. The strain-induced article of claim 1, wherein the styrenic copolymer has an Mw/Mn of less than 4.

3. The strain-induced article of claim 1, wherein the styrenic copolymer has Mw within a range from 100 kg/mole to 400 kg/mole.

4. The strain-induced article of claim 1, wherein at a temperature (T) of Tg+35° C. the styrenic copolymer exhibits strain hardening.

5. The strain-induced article of claim 1, wherein styrenic copolymer is a random copolymer.

6. The strain-induced article of claim 1, wherein the copolymer is partially or completely hydrogenated.

7. The strain-induced article of claim 1, wherein at least one of the aromatic hydrogen atoms is substituted.

8. The strain-induced article of claim 1, wherein the second aryl-containing monomer derived units are 4-vinylbiphenyl derived units or 4-vinylcyclohexylstyrene derived units.

9. A thermoformed or blow molded article comprising the strain-induced article of claim 1.

10. A foamed article comprising the strain-induced article of any one of claim 1.

11. A foamed, blow molded, or thermoformed article comprising poly(vinylbiphenyl-co-styrene) having a weight average molecular weight (Mw) of at least 100 kg/mole and an Mw/Mn of less than 4, comprising within the range from 5 to 80 wt % styrene derived units, wherein at a temperature of 190° C. the poly(vinylbiphenyl-co-styrene) exhibits strain hardening.

12. A process to form a strain-induced article comprising a styrenic copolymer having a weight average molecular weight (Mw) of at least 100 kg/mole, the process comprising combining styrene, a second aryl-containing monomer, and an initiator, followed by inducing shear on the formed styrenic copolymer to form the article, wherein the second aryl-containing monomer is selected from 4-vinylbiphenyl, substituted versions thereof, and partially hydrogenated versions thereof.

13. The process of claim 12, comprising controlling the rheological properties of styrenic copolymer by varying the amount of styrene combined with respect to second aryl-containing monomer and initiator.

14. The process of claim 12, comprising controlling the glass transition temperature (Tg) of the styrenic copolymer to within a range from 80° C. to 200° C. by varying the amount of styrene combined with respect to second aryl-containing monomer and initiator.

15. The process of claim 14, wherein the Tg the styrenic copolymer having 20 wt % styrene content is less than the Tg of the styrenic copolymer having 80 wt % styrene content.

16. The process of claim 12, wherein the level of such initiator in the reaction with the monomer is within a range from 0.0001 to 0.01 weight initiator/weight monomer ratio.

17. The process of claim 12, wherein the monomers and initiator are combined at a temperature within the range from 70° C. to 200° C.

18. The process of claim 12, wherein the styrenic copolymer has an Mw/Mn of less than 4.

19. The process of claim 12, wherein the styrenic copolymer has Mw within a range from 100 kg/mole to 400 kg/mole.

20. The process of claim 12, wherein at a temperature (T) of Tg+35° C. the styrenic copolymer exhibits strain hardening.

21. The process of claim 12, further comprising hydrogenating the styrenic copolymer either partially or completely.

22. The process of claim 12, further comprising blow molding or thermoforming a film or sheet of the styrenic copolymer into an article.

23. The process of claim 12, further comprising forming a foamed article comprising the styrenic copolymer.
